(19) United States
(12) Patent Application Publication
(10) Pub. No.: US 2025/0348832 A1
(43) Pub. Date: Nov. 13, 2025

(54) NEGOTIATION DEVICE, NEGOTIATION METHOD, AND STORAGE MEDIUM

(71) Applicant: NEC Corporation, Tokyo (JP)

(72) Inventor: Tomohito ANDO, Tokyo (JP)

(73) Assignee: NEC Corporation, Tokyo (JP)

(21) Appl. No.: 19/186,762

(22) Filed: Apr. 23, 2025

(30) Foreign Application Priority Data
May 9, 2024 (JP) 2024-076393

(51) Int. Cl. G06Q 10/083; G06Q 50/18

(52) U.S. Cl. CPC G06Q 10/083; G06Q 50/188

(57) ABSTRACT

The negotiation device 1X mainly includes a proposal acquisition means 32X and a unit size determination means 30X. The proposal acquisition means 32X is configured to, in conducting a negotiation with a negotiator which is a counterparty, acquire a proposal provided by the negotiator, wherein the proposal includes a delivery quantity of commodities with a delivery deadline. The unit size determination means 30X is configured to determine, based on the proposal, a unit size of the delivery quantity of the commodities, wherein the unit size is used to adjust the delivery deadline.

### INCORPORATION BY REFERENCE

This application is based upon and claims the benefit of priority from Japanese Patent Application No. 2024-076393, filed on May 9, 2024, the disclosure of which is incorporated herein in its entirety by reference.

### TECHNICAL FIELD

The present disclosure relates to a technical field of a negotiation device, a negotiation method, and a storage medium.

### BACKGROUND

A system is known in which automatic negotiations on the condition adjustment between an orderer and a contractor is performed. For example, Patent Literature 1 discloses an automatic negotiation system configured to previously store proposals for negotiations according to possible orders from the orderer and then preferentially select a proposal having the largest utility with respect to the terms and conditions of negotiations received from the orderer to transmit the selected proposal to the orderer.

### CITATION LIST

### Patent Literature

Patent Literature 1: WO2021/024414

### SUMMARY

When adjusting the due date (delivery deadline), it is fundamental to make the adjustment while observing the unit size of the delivery quantity stipulated by the following factors: MOQ (Minimum Order Quantity) which is the minimum quantity that can be ordered; SPQ (Standard Packing Quantity which is the smallest quantity that can be ordered, and SNP (Standard Number of Package) which is the packaging quantity at the time of shipment. On the other hand, there are cases where it is impossible to reach an agreement without relaxing the restriction of the unit size of the delivery quantity.

In view of the above-described issues, one object of the present disclosure is to provide a negotiation device, a negotiation method, and a program capable of suitably performing a delivery deadline adjustment.

In an example aspect of the present disclosure, there is provided a negotiation device including:
a proposal acquisition means configured to acquire, in conducting a negotiation with a negotiator which is a counterparty, a proposal provided by the negotiator, wherein the proposal includes a delivery quantity of commodities with a delivery deadline;
a unit size determination means configured to determine, based on the proposal, a unit size of the delivery quantity of the commodities, wherein the unit size is used to adjust the delivery deadline.

In an example aspect of the present disclosure, there is provided a negotiation method executed by a computer, including:
in conducting a negotiation with a negotiator which is a counterparty, acquiring a proposal provided by the negotiator, wherein the proposal includes a delivery quantity of commodities with a delivery deadline;
determining, based on the proposal, a unit size of the delivery quantity of the commodities, wherein the unit size is used to adjust the delivery deadline.

In an example aspect of the present disclosure, there is provided a program executed by a computer, the program causing the computer to:
in conducting a negotiation with a negotiator which is a counterparty, acquire a proposal provided by the negotiator, wherein the proposal includes a delivery quantity of commodities with a delivery deadline;
determine, based on the proposal, a unit size of the delivery quantity of the commodities, wherein the unit size is used to adjust the delivery deadline.

An example advantage according to the present disclosure is to suitably make delivery deadline adjustment.

### BRIEF DESCRIPTION OF THE DRAWINGS

FIG. 1 illustrates a configuration of the negotiation system.

FIG. 2 illustrates the hardware configuration of the platform providing device.

FIG. 3 illustrates the hardware configuration of the terminal device.

FIG. 4 illustrates an example of functional blocks in the negotiation platform.

FIG. 5A illustrates a table showing the correspondence between the offer agreed before negotiation and proposed offer on the order number “P000125” when the negotiator A has proposed the offer.

FIG. 5B illustrates a table showing the correspondence between the offer agreed before negotiation and proposed offer on the order number “P000125” when the negotiator B has proposed the counteroffer.

FIG. 5C illustrates a table showing the correspondence between the offer agreed before negotiation and proposed offer on the order number “P000125” when the negotiator A has proposed a new offer against the offer from the negotiator B.

FIG. 6 illustrates an example of a flowchart indicating the procedure of the process executed once the the negotiation AI which conducts automated negotiations for the negotiator A receives an offer from the counter-negotiator B.

FIG. 7 illustrates the configuration of the negotiation system.

FIG. 8 illustrates a functional block diagram of a negotiation device.

FIG. 9 illustrates an example of a flowchart showing a processing procedure of the negotiation device.

### EXAMPLE EMBODIMENTS

Hereinafter, example embodiments of a negotiation device, a negotiation method, and a storage medium will be described with reference to the drawings.

In the following explanation, the term “negotiation” refers to an adjustment of terms and conditions until the conclusion of an agreement between a party that places an order and a party that receives an order. In this example embodiment, the term “negotiations” mainly indicates actions taken by the parties to alternatively offer and counteroffer a proposal (also referred to as “offer”) for the agreement on the terms and conditions of the order. The negotiations in this case may be negotiations between parties with conflicting interest or may be negotiations (so-called adjustment) between parties without conflicting interest. Negotiations also include not only negotiations on general orders in which purchase orders are issued, but also adjustments to expected delivery quantities, etc., without issuing purchase orders. Also, examples of target terms and conditions (so-called issue) of negotiations include prices of products, due dates, quantities, means of transportation, resources (airspace if a drone is used as means of transportation), functions, and qualities. The term “negotiator” also refers to a subject that is responsible for placing an order and receiving an order, and has, for example, the ability to provide a proposal for agreement to the other negotiator, and the ability to determine whether or not to agree on the offer supplied from the other negotiator. The negotiator may be an individual or may be an organization. The negotiator may negotiate using an AI, a robotics, or any other device (including a drone and an autonomous vehicle) to reflect the intention of the individual or organization.

### First Example Embodiment

### (1) System Configuration

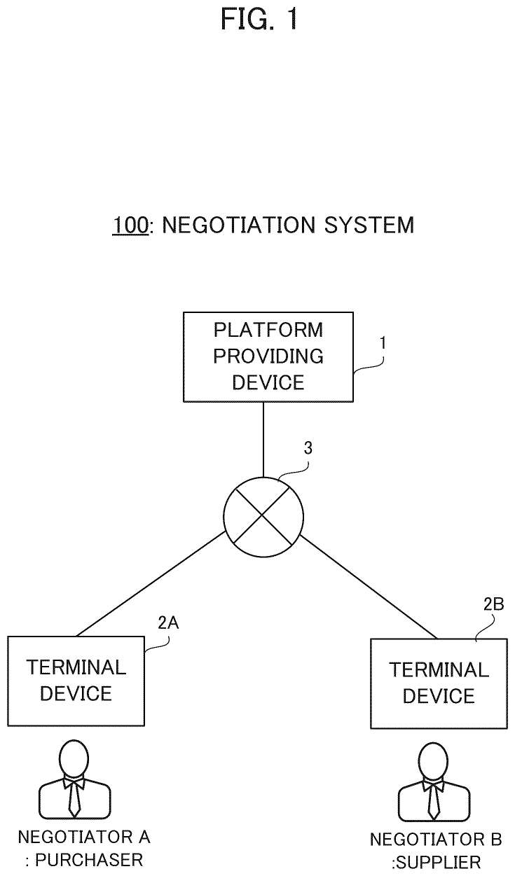

FIG. 1 illustrates the configuration of a negotiation system 100. The negotiation system 100 mainly includes a platform providing device 1 that provides an electronic negotiation platform for negotiating terms and conditions, and a terminal device 2A and a terminal device 2B that are used by negotiators that conduct negotiations on the negotiation platform provided by the platform providing device 1. The platform providing device 1, the terminal device 2A, and the terminal device 2B perform data communication via the network 3 with one another. In FIG. 1, as an example, a terminal device 2A usable by the negotiator A who is a purchaser of parts (components), and a terminal device 2B usable by the negotiator B who is a part (component) supplier are illustrated, and hereafter, when the terminal device 2A and the terminal device 2B are not particularly distinguished, these are simply referred to as “terminal device 2”.

Hereinafter, the negotiations between the negotiator A and the negotiator B on a one-to-one basis will be described as an example. It is noted that negotiations with competitive quotes, total amount negotiations, nested negotiations may be performed by combining a plurality of one-to-one basis negotiations to be described below.

The platform providing device 1 provides a negotiation platform required for negotiations on the terms and conditions between the negotiator A and the negotiator B through the terminal device 2A and the terminal device 2B. The negotiator A is a purchaser of parts (components) of products and the negotiator B is a part supplier who supplies the parts. The platform providing device 1 generates display information required for display of information required for negotiations, and transmits the generated display information to the terminal device 2A and the terminal device 2B to control the display of the terminal device 2A and the terminal device 2B. In this instance, the platform providing device 1 receives the input information related to the offer from the terminal device 2A and the terminal device 2B and generates the above-described display information based on the received input information. The platform providing device 1 is an example of the “negotiation device”.

The terminal device 2 (2A, 2B) are communication devices used by the negotiators, and, on the basis of the data communication with the platform providing device, displays the information or accepts the input from the negotiators. In the present example embodiment, as an example, the negotiator A shall conduct automated negotiations through a negotiation AI (the description of the negotiation AI will be given later) in principle, and the negotiator B shall conduct negotiations (hereinafter, also referred to as “manual-based negotiations”) based on a manual input through the terminal device 2B without using any negotiation AI. It is noted that upon determining that the automated negotiations by the negotiation AI does not lead to an agreement, or upon determining, in other cases, that manual-based negotiations are required, the negotiator A can switch to the manual-based negotiations which require user input through the terminal device 2A.

The configuration of the negotiation system 100 shown in FIG. 1 is an example, and various changes may be made to the configuration. For example, the platform providing device 1 may be configured by a plurality of devices. In this case, the plurality of devices constituting the platform providing device 1 performs transmission and reception of information necessary for executing the pre-allocated process among the plurality of devices.

### (2) Hardware Configuration

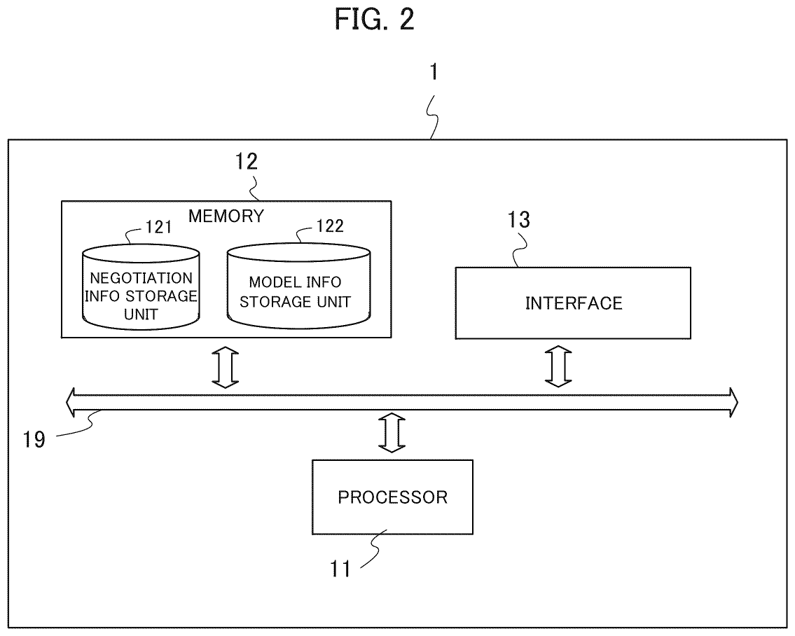

FIG. 2 shows the hardware configuration of the platform providing device 1. The platform providing device 1 includes a processor 11, a memory 12, and an interface 13 as hardware. The processor 11, memory 12 and interface 13 are connected to one another via a data bus 19.

The processor 11 executes a predetermined process by executing a program stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by various volatile memories and non-volatile memories such as a RAM (Random Access Memory) and a ROM (Read Only Memory). The memory 12 further stores a program for executing various process by the platform providing device 1. The memory 12 is also used as a working memory.

The memory 12 functionally includes a negotiation information storage unit 121 and a model information storage unit 122.

The negotiation information storage unit 121 stores the negotiation information which is information regarding the negotiations between the negotiator A and the negotiator B. The negotiation information includes information on the offer (i.e., the proposal before the ongoing negotiations) currently agreed between the negotiator A and the negotiator B. The offer at least indicates delivery deadlines and respective delivery quantities of commodities for the delivery deadlines. In the following, delivery of commodities in installments by dividing them into several deadlines is also referred to as “installment delivery” or “partial delivery”. In the case of the installment delivery of commodities, plural delivery deadlines for delivering the commodities and the delivery quantity at each of the delivery deadlines are at least specified. In some embodiments, order numbers are assigned to commodities subject to orders (i.e., target commodities of delivery) according to the types of the commodities. In this case, the offer indicates a proposal (draft) of terms and conditions relating to plural order numbers. In addition, negotiation information includes information regarding MOQ, SPQ, SNP settled between negotiators.

The model information storage unit 122 stores model information (including parameters) for configuring a negotiation AI which is an artificial intelligence model for negotiating with the other negotiator as an agent for the negotiator. The negotiation AI is utilized for negotiating with the other negotiator (here, negotiator B) by the negotiator A which is an individual or an organization.

The negotiation AI include an acceptance strategic function that makes a determination (so-called acceptance determination) as to whether or not to agree on an offer provided by the other negotiator, and an offer generation function that generates an offer. Examples of the offer generation include the generation of an alternative offer (also referred to as “counteroffer”) upon determining that the offer provided by the other negotiator cannot be agreed upon. Any technique may be used to generate an offer, such as beam search, grid search, search by probabilistic optimization such as a genetic algorithm, search by Bayesian optimization, and a combination thereof. In some embodiments, the negotiation AI may calculate the utility (degree of utility) using the utility function for calculating the degree of goodness of the offer, and then, based on the utility, makes the acceptance determination as to the offer supplied from the other negotiator and determines an offer to provide with the other negotiator. For example, the negotiation AI may decide to accept an offer whose utility is greater than or equal to a predetermined threshold value, and may decide not to accept an offer whose utility is less than the above-mentioned threshold value. The negotiation AI may also make plural options for an offer, and determine the offer by selecting the option having the highest utility to notify the other negotiator. It is noted that a method of determining an offer based on a utility function is disclosed in, for example, Patent Literature 1.

The interface 13 is one or more interfaces for electrically connecting the platform providing device 1 to other devices. Examples of the interfaces include a wireless interface, such as network adapters, for transmitting and receiving data to and from other devices wirelessly, and a hardware interface, such as a cable, for connecting to other devices.

The hardware configuration of the platform providing device 1 is not limited to the configuration shown in FIG. 2. For example, the platform providing device 1 may include at least one of an input device, a display device, and/or a sound output device. At least a portion of the information stored in the memory 12 may be stored in one or more storage devices other than the platform providing device 1. In this case, examples of the storage devices include a hard disk connected to the platform providing device 1, a storage medium such as a flash memory, and a server device that performs data communication with the platform providing device 1.

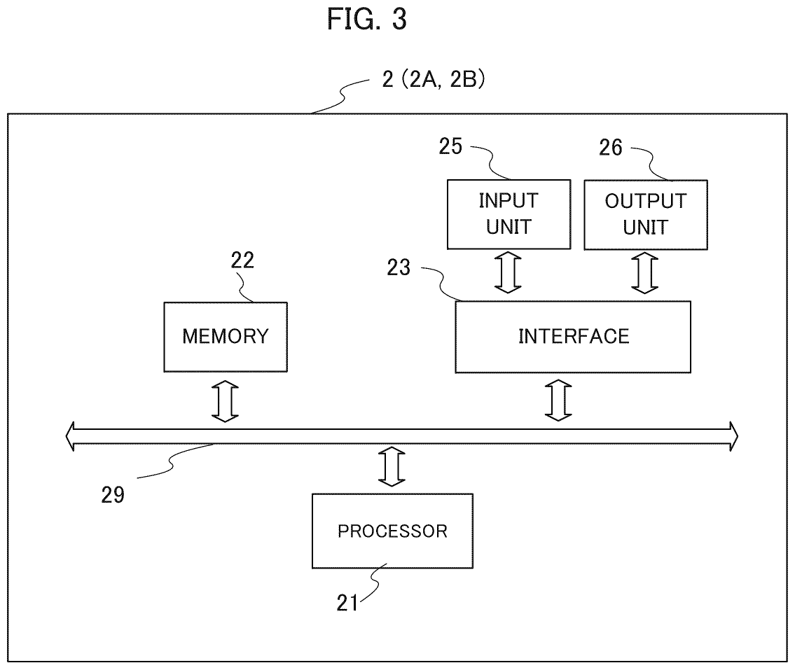

FIG. 3 shows the hardware configuration of the terminal device 2, that is, the hardware configuration common to the terminal device 2A and the terminal device 2B. The terminal device 2 includes a processor 21, a memory 22, and an interface 23 as hardware. The processor 21, memory 22, and interface 23 are connected to one another via a data bus 29.

The processor 21 executes a predetermined process by executing a program stored in the memory 22. Examples of the processor 21 is a processor such as a CPU, a GPU, and a TPU. The processor 21 may be configured by a plurality of processors. The processor 21 is an example of a computer.

The memory 22 is configured by various volatile memories and non-volatile memories such as a RAM (Random Access Memory) and a ROM (Read Only Memory). Further, in the memory 22, a program for executing various processes by the platform providing device 1 is stored. The memory 22 is also used as a working memory.

The interface 23 is one or more interfaces for electrically connecting the terminal device 2 to other devices. Examples of the interfaces include a wireless interface, such as a network adapter, for transmitting and receiving data to and from other devices wirelessly, and a hardware interface, such as a cable, for connecting to other devices.

The interface 23 performs the interface operation of the input unit 25 and the output unit 26. The input unit 25 is a user interface that receives an input that is an external input, and examples of the input unit 25 include a touch panel, a button, a keyboard, and a voice input device. The interface 23 supplies the input signal generated by the input unit 25 to other components in the terminal device 2 or a device existing outside the platform providing device 1. The output unit 26 performs display or audio output of predetermined information based on the output signal supplied through the interface 23. Examples of the output unit 26 include a display, a projector, and an audio output device.

The hardware configuration of the terminal device 2 is not limited to the configuration shown in FIG. 3. For example, at least one of the input unit 25 and/or the output unit 26 may be configured separately from the terminal device 2.

### (3) Overview of Negotiation Platform

Next, an outline of a negotiation platform realized by the platform providing device 1 will be described. The platform providing device 1 appropriately sets, based on the offer provided by the negotiator B which is a supplier, the unit size (i.e., the unit of order) of the delivery quantity of the commodities used for generation of the offer from the negotiator A.

Generally, SPQ, MOQ, and SNP are set by the convenience of the supplier who is a part supplier. Therefore, it is often inappropriate to ease the restrictions from the negotiator A who is a part purchaser. In contrast, it is justified for the negotiator B who is a supplier to ease the restrictions on the delivery quantity such as SPQ, MOQ, and SNP. Taking the above into consideration, the platform providing device 1 flexibly sets the unit size of the delivery quantity of the commodities according to the offer from the negotiator B which is a supplier. This enables the platform providing device 1 to generate an offer with installment delivery in which the restriction on the unit size of the delivery quantity is adequately relaxed according to the supplier's offer, allowing the delivery deadline to be adjusted more flexibly.

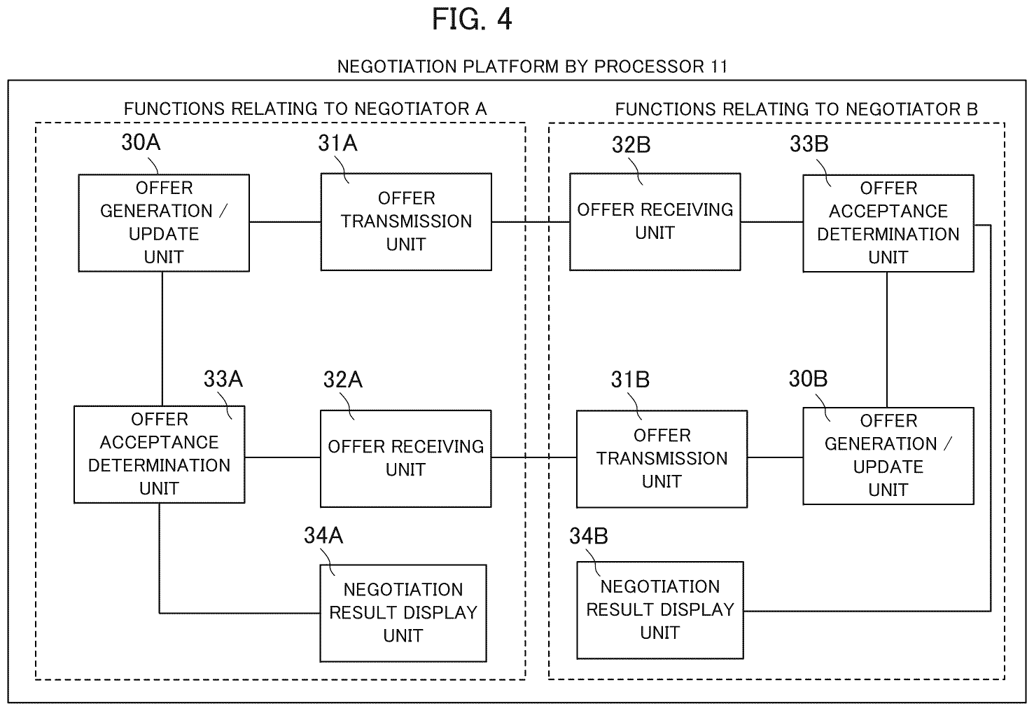

FIG. 4 is an example of a functional block in a negotiation platform implemented by the processor 11 of the platform providing device 1. The negotiation platform includes an offer generation/update unit 30A, an offer transmission unit 31A, an offer receiving unit 32A, an offer acceptance determination unit 33A, and a negotiation result display unit 34A as functions relating to the negotiator A. The negotiation platform includes an offer generation/update unit 30B, an offer transmission unit 31B, an offer receiving unit 32A, an offer acceptance determination unit 33B, and a negotiation result display unit 34B as functions relating to the negotiator B. In FIG. 4, blocks to exchange data with each other are connected by a solid line, but the combination of the blocks to exchange data with each other is not limited thereto. The same applies to the drawings of other functional blocks described below.

First, the functions relating to the negotiator A will be described.

The offer generation/update unit 30A generates and updates an offer by the negotiation AI. The term “updating an offer” refers to generating a counteroffer upon determining that an offer supplied from the negotiator B is unacceptable. In this case, for example, the processor 11 configures the negotiation AI referring to the model information stored in the model information storage unit 122 and executes the process related to the offer generation/update unit 30A. The negotiation AI generates an offer based on the negotiation information and the like stored in the negotiation information storage unit 121. Upon receiving, from the offer acceptance determination unit 33A, the latest offer and the determination result indicating the refusal of the offer, the negotiation AI updates the received offer. The offer generation/update unit 30A supplies the generated or updated offer to the offer transmission unit 31A.

In updating the offer, the offer generation/update unit 30A sets the unit size of the delivery quantity of the commodities based on the received offer. Specifically, the offer generation/update unit 30A determines, based on the received offer, the necessity of change in the unit size of the delivery quantity of the commodities. Then, upon determining that the unit size needs to be changed, it changes the unit size of the delivery quantity of the commodities. The default value of the unit size of the delivery quantity of the commodities is a unit size defined by at least one of MOQ, which is the minimum quantity of order, SPQ, which is the smallest unit in the order, and/or SNP, which is the number of the commodities per package at the time of shipment. The unit size defined by at least one of MOQ, SPQ, and/or SNP is an example of the “default unit size”.

The offer transmission unit 31A supplies information indicating the offer generated or updated by the offer generation/update unit 30A to the offer receiving unit 32B. For example, the processor 11 functions as an offer transmission unit 31A to generate display information for displaying the offer generated or updated by the offer generation/update unit 30A on the terminal device 2B. Then, the processor 11 transmits the generated display information to the terminal device 2B through the interface 13.

The offer receiving unit 32A receives information indicating an offer supplied from the offer transmission unit 31B, which will be described later. In this case, for example, the processor 11 functions as an offer receiving unit 32A and receives information indicating an offer supplied from the offer transmission unit 31B to be described later.

The offer acceptance determination unit 33A determines whether or not to accept (i.e., agree on) the offer which the offer receiving unit 32A has received. In this case, for example, the processor 11 configures the negotiation AI with reference to the model information stored in the model information storage unit 122 and executes the process related to the offer acceptance determination unit 33A. Upon determining that the offer which the offer receiving unit 32A has received is acceptable, the offer acceptance determination 33A supplies information (i.e., information indicating the offer received by the offer receiving unit 32A) indicating the agreed offer to the negotiation result display unit 34A. The offer acceptance determination unit 33A may also provide the negotiation result displaying unit 34B with information indicating the agreed offer.

Upon determining that the offer received by the offer receiving unit 32A is not acceptable and it is necessary to switch to the manual-based negotiations, the offer acceptance determination unit 33A supplies information indicating the offer at the present time to the negotiation result display unit 34A. The offer acceptance determination unit 33A may supply the above-described information to the negotiation result display unit 34B in the same manner. For example, the offer acceptance determination unit 33A needs to switch to manual-based negotiations upon determining the offer which the offer receiving unit 32A received at the last time has no change (i.e., the negotiations are not advanced) from the offer which the offer receiving unit 32A received at the last but one time. In another instance, upon receiving a request for the suspension of negotiations from the negotiator B, the offer acceptance determination unit 33A determines that the negotiations should be switched to manual-based negotiations.

On the other hand, upon determining that the offer which the offer receiving unit 32A has received is not acceptable and there is no need to switch to manual-based negotiations, the offer acceptance determination unit 33A supplies the information indicating the received offer and the determination result indicating that the offer cannot be accepted to the offer generation/update unit 30A. The offer acceptance determination unit 33A determines that there is no need to switch to manual-based negotiations if there is a substantial variation between the last offer received by the offer receiving unit 32A and the last but one offer received by the offer receiving unit 32A. In another instance, the offer acceptance determination unit 33A determines that it is not necessary to switch to manual-based negotiations if there is no request for suspension of negotiations from the negotiator B.

The negotiation result display unit 34A displays on the terminal device 2A the negotiation result based on the information received from the offer acceptance determination unit 33A. In this instance, the processor 11 functions as the negotiation result display unit 34A to generate display information based on the information received from the offer acceptance determination unit 33A and supplies the generated display information to the terminal device 2A. For example, if the offer is agreed, the negotiation result display unit 34A displays on the terminal device 2A the information on the agreed offer based on the information received from the offer acceptance determination unit 33A. In some embodiments, the negotiation result display unit 34A may display the negotiation result based on the information received from the offer acceptance determination unit 33B on the terminal device 2A once the offer acceptance determination unit 33B has decided to suspend the negotiations.

Next, a description will be given of the function relating to the negotiator B.

The offer receiving unit 32B receives information indicating the offer supplied from the offer transmission unit 31A. In this case, for example, the terminal device 2B functions as an offer receiving unit 32B under the control of the processor 11, and receives information indicating an offer supplied from the offer transmission unit 31A through the interface 23.

The offer acceptance determination unit 33B determines, based on the information input by the negotiator B, whether or not to accept (i.e., agree on) the offer received by the offer receiving unit 32B. In this case, the processor 11 functions as the offer acceptance determination unit 33B by controlling the terminal device 2B.

In the acceptance determination of the offer, under the control of the processor 11, the terminal device 2B displays the offer provided by the negotiator A based on the information received by the offer receiving unit 32B to receive a user input for specifying whether or not agree on the offer and whether or not to suspend the negotiations. Then, the terminal device 2B transmits the received input information to the platform providing device 1, and the processor 11 determines whether or not to accept (i.e., agree on) the offer on the basis of the input information received from the terminal device 2B.

Upon determining that the offer has come to an agreement, the offer acceptance determination unit 33B supplies the information indicating the agreed offer (i.e., information indicating the offer received by the offer receiving unit 32B) to the negotiation result display unit 34B. Upon determining that there is no agreement on the entire offer and that there is an input specifying the suspension of the ongoing negotiations, the offer acceptance determination unit 33B determines that the ongoing negotiations should be suspended and supplies the information indicating the current offer to the negotiation result display unit 34B. The offer acceptance determination unit 33B may supply the above information to be supplied to the negotiation result display unit 34B to the negotiation result display unit 34A. If there is no agreement on the offer and there is no input specifying the suspend of the negotiations, the offer acceptance determination unit 33B supplies the information indicating the offer and the determination result indicating that the offer cannot be accepted to the offer generation/update unit 30B.

The offer generation/update unit 30B generates and updates the offer. In this case, the processor 11 functions as the offer generation/update unit 30B by controlling the terminal device 2B. For example, upon receiving the determination result indicating that the offer is not acceptable from the offer acceptance determination unit 33B, the offer generation/update unit generates a counteroffer based on input from the negotiator B. The terminal device 2B receives the input specifying the counteroffer and transmits the received input information to the platform providing device 1. The offer generation/update unit 30B may generate a new offer based on the input information received at any timing.

In generating and updating the offer, the offer generation/update unit 30B does not impose a limitation on the unit size of the delivery quantity of the commodities, and receives a user input specifying a plurality of delivery quantities at any unit size and corresponding delivery deadlines in installments. In other words, the offer generation/update unit 30B determines, based on the user input, the delivery quantities and the corresponding delivery deadlines according to the installment delivery of the commodities, regardless of the default unit size of the delivery quantity specified by MOQ, SPQ, SNP, or the like. In this way, the platform providing device 1 receives the designation of the delivery quantity of the commodities with a finer unit size than the default unit size defined by MOQ, SPQ, SNP or the like from the negotiator (the negotiator B in this case) serving as a supplier.

The offer transmission unit 31B supplies information indicating the offer generated or updated by the offer generation/update unit 30B to the offer receiving unit 32A. In some embodiments, the offer transmission unit 31B may supply information indicating an offer which includes the delivery quantity of commodities at a unit size smaller than the default unit size defined by a MOQ, SPQ, SNP or the like to the offer receiving unit 32A. For example, the processor 11 functions as the offer transmission unit 31B.

The negotiation result display unit 34B displays on the terminal device 2B the negotiation result based on the information received from the offer acceptance determination unit 33B. In this instance, the processor 11 functions as the negotiation result display unit 34B to generate display information based on the information received from the offer acceptance determination unit 33B and supplies the generated display information to the terminal device 2B. For example, if the offer has come to an agreement, the negotiation result display unit 34B displays the information on the agreed offer on the terminal device 2B based on the information received from the offer acceptance determination unit 33B. The negotiation result display unit 34B may display the negotiation result based on the information received from the offer acceptance determination unit 33A on the terminal device 2B once the offer acceptance determination unit 33A has determined the suspend of the negotiations.

The respective components of the offer generation/update unit 30A, the offer transmission unit 31A, the offer acceptance determination unit 33A, the negotiation result display unit 34A, the offer generation/update unit 30B, the offer transmission unit 31B, the offer acceptance determination unit 33B, and the negotiation result display unit 34B described in FIG. 4 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using a user programmable integrated circuit such as a FPGA (Field-Programmable Gate Array) and a microcontroller. In this case, the integrated circuit may be used to realize a program to function as each of the above components. Further, at least some of the components may be realized by ASSP (Application Specific Standard Produce), ASIC (Application Specific Integrated Circuit), or quantum processor (quantum computer control chip). Thus, each component may be implemented by various hardware. The above is also true for other example embodiments described later. Furthermore, each of these components may be implemented by the cooperation of a plurality of computers, for example, using cloud computing technology.

### (4) Setting of Unit Size of Delivery Quantity

Next, a specific example of a method of setting the unit size of the delivery quantity of the commodities for the offer generation by the automated negotiations will be described. For example, the platform providing device 1 sets the unit size of the delivery quantity for each unit of commodities based on any of the following methods.

In the first setting method, the platform providing device 1 determines the unit size based on the largest common divisor of the set of the delivery quantities (i.e., respective delivery quantities in installments) of the commodities in the offer agreed before the ongoing negotiations. For example, if the set of delivery quantities of commodities before the ongoing negotiations is {7500, 15000}, the largest common divisor is “7500”, so the platform providing device 1 estimates that the appropriate unit size of the delivery quantity of the commodities is “7500”. For example, the offer agreed before the ongoing negotiations is identified by referring to the negotiation information stored in the negotiation information storage unit 121. By using the first setting method, the platform providing device 1 can appropriately set the unit size of the delivery quantity of the product if there is no offer yet from the counterparty in the ongoing negotiations.

In the second setting method, the platform providing device 1 sets the unit size based on the largest common divisor of the union of the set of the delivery quantities of the commodities in the offer agreed before the ongoing negotiations and the set of the delivery quantities of the commodities in the offer supplied from the counterparty in the ongoing negotiations. For example, if the set of the delivery quantities of particular commodities in the offer agreed before the ongoing negotiations is {7500, 15000} and the set of the delivery quantities in the offer supplied from the counterparty in the ongoing negotiations is {5000, 15000}, the largest common divisor of the union {5000, 7500, 15000} of the sets is “2500” and thus the platform providing device 1 estimates that the appropriate unit size of the delivery quantity of the particular commodities is “2500”. By using the second setting method, the platform providing device 1 can set the unit size of the delivery quantity of the commodities if there is an offer from the counterparty in the ongoing negotiations. The platform providing device 1 may use, as the unit size of the delivery quantity, the largest common divisor of the set of the delivery quantities of the commodities in the offer from the counterparty, instead of using the largest common divisor of the union described above as the unit size of the delivery quantity.

In the third setting method, the platform providing device 1 corrects the default unit size in consideration of a case where the unit size determined by the first setting method or the second setting method is too fine (i.e., too small). For example, the platform providing device 1 selects, from the unit sizes or their multiples determined by the first setting method or the second setting method, the unit size closest to ¼ of the largest delivery quantity among the set of the delivery quantities used to determine the unit size. For example, if the unit size determined by the first setting method or the second setting method is “2500” and the largest delivery quantity among the set of delivery quantities used to determine the unit size is “20000”, it selects the delivery quantity “5000” closest to ¼ of the largest delivery quantity “20000” as the unit size of the delivery quantity to be used finally. The parameter “¼” used in the above correction is an example, and an arbitrary value instead may be used. As such, the platform providing device 1 can determine the unit size of the delivery quantity based on the maximum delivery quantity among the set of delivery quantities used to determine the unit size.

In some embodiments, the platform providing device 1 may generate an offer without changing the unit size of the delivery quantity if the unit size of the delivery quantity calculated by any one of the first to third setting methods is coarser than (i.e., larger than) the current setting of the unit size. For example, if the unit size of the delivery quantity determined by any of the first to third setting methods is larger than the default unit size of the delivery quantity defined by MOQ, SPQ, SNP or the like, the platform providing device 1 generates an offer based on the unit size of the delivery quantity defined by MOQ, SPQ, SNP or the like.

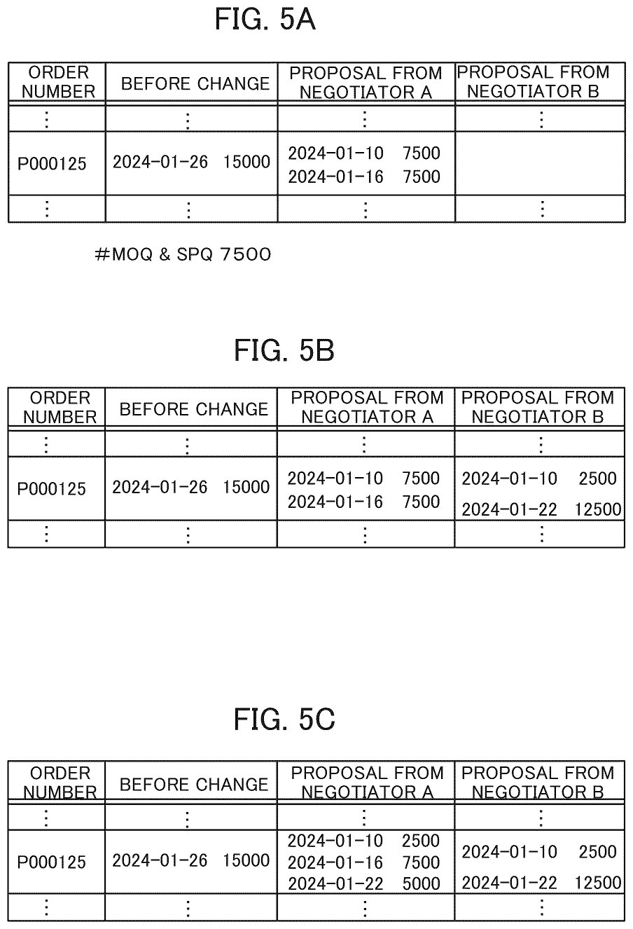

FIG. 5A is a table showing the correspondence between the offer agreed before the ongoing negotiations and the offer proposed by the negotiator A regarding the ordering number “P000125”. The table shown in FIG. 5A has the following items: “ORDER NUMBER”, “BEFORE CHANGE”, “PROPOSAL FROM NEGOTIATOR A”, and “PROPOSAL FROM NEGOTIATOR B”. The item “ORDER NUMBER” indicates order numbers assigned to units of the commodities to be delivered. The item “BEFORE CHAGE” indicates the offer agreed before the ongoing negotiations (i.e., before the negotiator B proposes an offer). The item “PROPOSAL FROM NEGOTIATOR A” indicates the offer proposed by the negotiator A. The item “PROPOSAL FROM NEGOTIATOR B” indicates the offer proposed by the negotiator B. In this negotiation, the item “PROPOSAL FROM NEGOTIATOR B” is blank because negotiator B has not proposed an offer yet. It is noted that each field of the items “BEFORE CHANGE”, “PROPOSAL FROM NEGOTIATOR A”, and “PROPOSAL FROM NEGOTIATOR B” exemplarily indicates the terms and conditions related to the delivery deadline (year-month-day) and the quantity of commodities for each order number, but any other terms and conditions such as price, transportation means, and the like may further be negotiated.

In the example shown in FIG. 5A, the negotiation AI recognizes that the unit size of the delivery quantity is “7500” since MOQ and SPQ are set to “7500”, and therefore generates an offer regarding the order number “P000125” in installments using the unit size “7500”. Specifically, it generates an offer with the first installment of delivery of 7500 pieces on on Jan. 10, 2024 and the second installment of delivery of 7500 pieces on Jan. 16, 2024 for the commodities with the order number “P000125”.

FIG. 5B is a table showing the correspondence between the offer agreed before the ongoing negotiations and the proposed offer regarding the order number “P000125” after the counteroffer from negotiator B has been proposed. As shown in FIG. 5B, in this instance, the negotiator B, who conducts manual-based negotiations, proposes an offer of the installment delivery regarding the order number “P000125” in units of 2500 pieces, which is finer than MOQ and SPQ set to “7500”, through the manual input to the terminal device 2B. Specifically, it generates an offer which includes a first installment of delivery of 2500 pieces on Jan. 10, 2024 and a second installment of delivery of 12500 pieces on Jan. 22, 2024 regarding the commodities of the order number “P000125”.

In this way, for the negotiator B who is a supplier, the platform providing device 1 permits the generation of the offer at any unit size of the delivery quantity regardless of MOQ and SPQ.

FIG. 5C is a table showing the correspondence between the offer agreed before the ongoing negotiations and the proposed offer regarding the order number “P000125” at the time when the negotiator A has proposed a new offer against the offer from the negotiator B.

In the example shown in FIG. 5C, the negotiation AI, which automatically generates an offer as a representative of the negotiator A, sets the unit size of the delivery quantity used in generating the offer to a unit size, based on the offer proposed by negotiator B, which is smaller than MOQ and SPQ.

Specifically, based on the second setting method described above, the negotiation AI calculates the largest common divisor “2500” of the union {2500, 12500, 15000} of the set {15000} of the delivery quantities in the offer agreed before the ongoing negotiation and the set {2500, 12500} of the delivery quantities in the offer from the negotiator B. Then, the negotiation AI sets the calculated largest common divisor “2500” as a new unit size of the delivery quantity. Then, the negotiation AI generates an offer in the installment delivery according to the determined unit size “2500” for the commodities with the order number “P000125”. Here, regarding the order number “P000125”, there is generated an offer which includes the first installment of delivery of 2500 pieces on Jan. 10, 2024, the second installment of delivery of 7500 pieces on Jan. 16, 2024, and the third installment of delivery of 5000 pieces on Jan. 22, 2024, respectively.

In this way, the negotiation AI flexibly sets the unit size of the delivery quantity that can be set by negotiator A according to the offer from the negotiator B, who is a supplier. This allows the negotiation AI to generate an offer in installments so as to adjust the delivery deadline more flexibly and reach an agreement with the counterparty.

### (5) Processing Flow

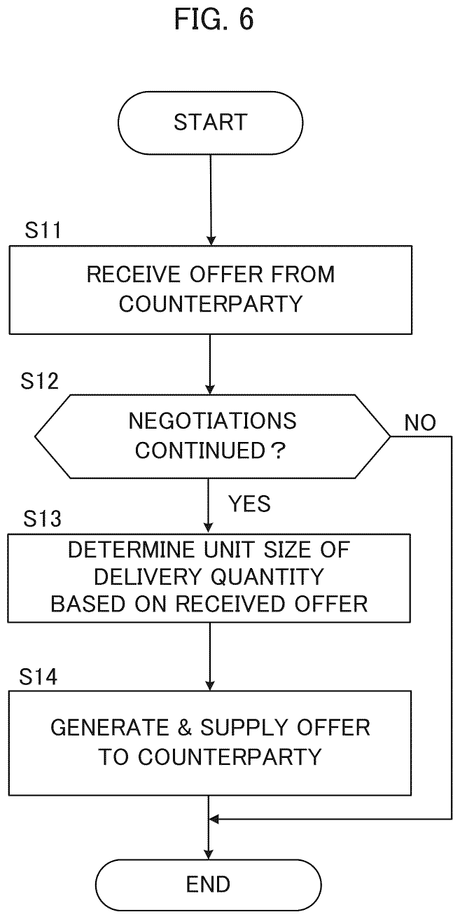

FIG. 6 is an example of a flowchart illustrating a procedure of the process executed by the negotiation AI, which conducts automated negotiations as substitute for the negotiation A in response to receiving an offer from the negotiator B who is a supplier.

First, the negotiation AI that conducts automated negotiations as substitute for the negotiator A receives an offer from the negotiator B, which is the counterparty (step S11). In this instance, the negotiator B, who is a supplier, inputs an offer through the terminal device 2B without considering the restriction (constraint) such as MOQ, SPQ, and SNP, and the platform providing device 1 inputs information indicating the specified offer to the negotiation AI on the basis of input information received from the terminal device 2B.

The negotiation AI then determines, based on the received offer, whether or not the negotiations should continue (step S12). For example, the negotiation AI determines that the negotiations should continue upon determining that the received offer is not acceptable and the negotiations should not be suspended. On the other hand, the negotiation AI determines that the negotiation should not continue upon determining that the received offer is acceptable or the negotiations should be suspended.

Upon determining that the negotiations should continue (step S12; Yes), the negotiation AI determines the unit size of the delivery quantity based on the offer received at step S11 (step S13). In this case, the negotiation AI updates the unit size of the delivery quantity upon determining that the unit size of the delivery quantity determined based on the offer received at step S11 is smaller than the current unit size. It is noted that the negotiation AI may determine the unit sizes of the delivery quantity for respective units of commodities if plural units of commodities are ordered in the offer.

Then, the negotiation AI generates a counteroffer against the offer provided at step S11, and notifies the counterparty of the generated counteroffer (step S14). In this case, if the unit size of the delivery quantity is smaller than SPQ, MOQ, or SNP is set at step S13, the negotiation AI generates the counteroffer in the installment delivery using the set unit size of the delivery quantity. This enables the negotiation AI to relax constraints such as SPQ, MOQ, SNP to generate an offer in appropriate installments, allowing for flexible adjustment of the delivery deadline.

On the other hand, upon determining that the negotiations should not continue (step S12; No), the negotiation AI terminates the process of the flowchart. For example, upon determining that the negotiation AI has agreed on the offer provided at step S11, the platform providing device 1 stores information indicating the offer agreed between the negotiators in the negotiation information storage unit 121 in association with the agreed time information or the like. In another example, once the negotiation AI determines that the negotiations should be suspended, the platform providing device 1 displays the negotiation result on the terminal device 2A and the terminal device 2B.

### (4) Modifications

Next, a description will be given of a modification applicable to the example embodiment described above. The following modifications may be applied in any combination.

### (First Modification)

Instead of making manual-based negotiations, the negotiator B may perform automated negotiations using a negotiation AI.

In this instance, the offer generation/update unit 30B and the offer acceptance determination unit 33B shown in FIG. 4 perform acceptance determination, generation, and update of the offer by the negotiation AI instead of performing acceptance determination, generation, and update of the offer based on the input information received from the terminal device 2B. In this instance, the process executed by the offer generation/update unit 30B and the offer acceptance determination unit 33B is the same as the process performed by the offer generation/update unit 30A and the offer acceptance determination unit 33A described with reference to FIG. 4. In some embodiments, the offer generation/update unit 30B may generate an offer according to the installment delivery using any unit size of the delivery quantity regardless of SPQ, MOQ, and SNP.

Even in this case, the platform providing device 1 relaxes the constraints such as SPQ, MOQ, SNP and can flexibly adjust the delivery deadline.

### (Second Modification)

The negotiation AI may be executed by the terminal device 2A, instead of being executed by the platform providing device 1.

In this case, the terminal device 2A stores in the memory 22 the model information in place of the model information storage unit 122, and the processor 21 of the terminal device 2A executes the negotiation AI by referring to the model information. Also in this modification, it is possible to suitably realize the automated negotiations for the negotiator A.

### (Third Modification)

The functions of the platform providing device 1 may be incorporated in the terminal device 2.

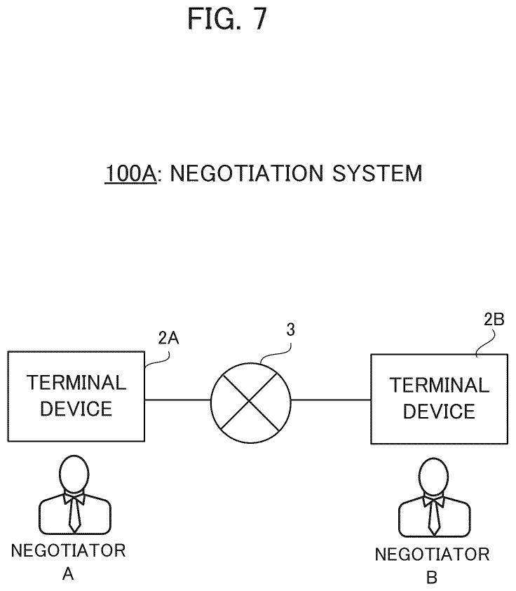

FIG. 7 shows a configuration of a negotiation system 100A. The negotiation system 100A includes a terminal device 2A used by the negotiator A and a terminal device 2B used by the negotiator B. The terminal device 2A and the terminal device 2B performs data communication with each other via the network 3. Then, at least one of the terminal device 2A and/or the terminal device 2B executes the process performed by the platform providing device 1 in FIG. 1 to realize a negotiation platform.

As shown in FIG. 7, even in a mode in which the terminal devices 2 used for negotiations performs data communication with each other, the terminal devices 2 can exchange information necessary for the negotiations to suitably execute the processes related to the notification and acceptance of the offer.

### Second Example Embodiment

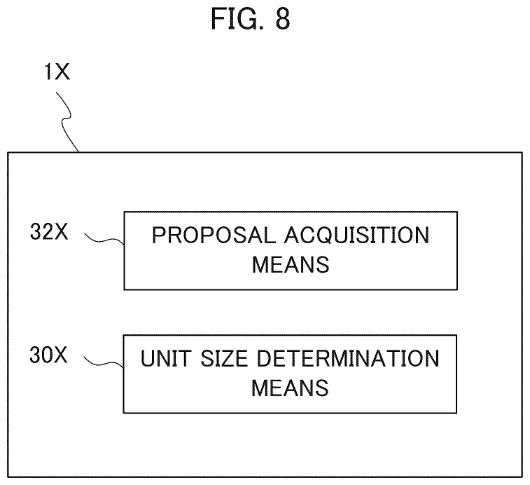

FIG. 8 is a functional block diagram of the negotiation device 1X. The negotiation device 1X mainly includes a proposal acquisition means 32X and a unit size determination means 30X. The negotiation device 1X may be configured by a plurality of devices. Examples of the negotiation device 1X include the platform providing device 1 shown in FIG. 1 and the terminal device 2A or the terminal device 2B whichever executes the negotiation AI in substitute for the negotiator A shown in FIG. 11.

The proposal acquisition means 32X is configured to, in conducting a negotiation with a negotiator which is a counterparty, acquire a proposal provided by the negotiator, wherein the proposal includes a delivery quantity of commodities with a delivery deadline. Examples of the proposal acquisition means 32X include the the offer receiving unit 32A in the first example embodiment.

The unit size determination means 30X is configured to determine, based on the proposal, a unit size of the delivery quantity of the commodities, wherein the unit size is used to adjust the delivery deadline. Examples of the unit size determination means 30X includes the offer generate/update unit 30A in the first example embodiment.

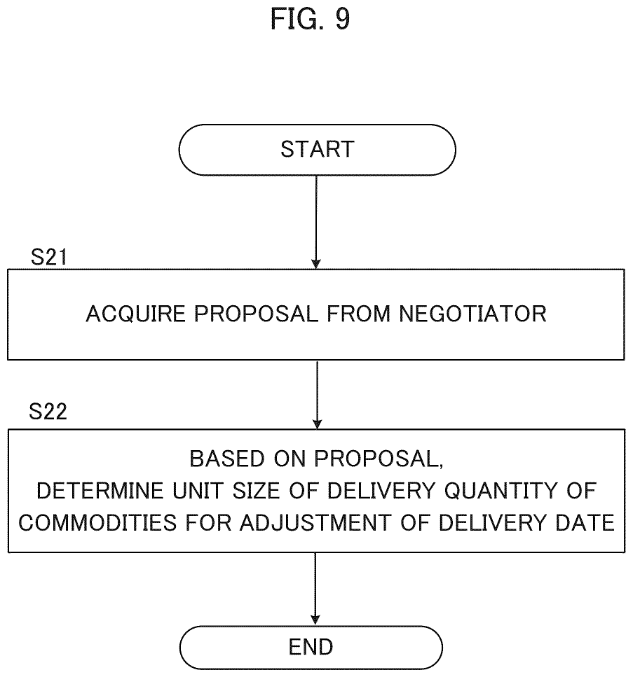

FIG. 9 is an example of the flowchart executed by the negotiation device 1X. The proposal acquisition means 32X acquires, in conducting a negotiation with a negotiator which is a counterparty, a proposal provided by the negotiator, wherein the proposal includes a delivery quantity of commodities with a delivery deadline (step S21). The unit size determination means 30X determines, based on the proposal, a unit size of the delivery quantity of the commodities, wherein the unit size is used to adjust the delivery deadline (step S22).

The negotiation device 1X according to the second embodiment can flexibly determine the unit size of the delivery quantity of the commodities when adjusting the delivery deadline in accordance with the proposal provided by the counterparty.

In addition, some or all of the above-described example embodiments (including modifications, the same shall apply hereinafter) may also be described as follows, but are not limited to the following. In addition, some or all of the configurations described in Supplementary Notes 2 to 8 which are dependent on Supplementary Note 1 may be dependent on Supplementary Notes 9 and 10 by the same dependence as Supplementary Notes 2 to 8. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### [Supplementary Note 1]

A negotiation device comprising:
a proposal acquisition means configured to acquire, in conducting a negotiation with a negotiator which is a counterparty, a proposal provided by the negotiator, wherein the proposal includes a delivery quantity of commodities with a delivery deadline;
a unit size determination means configured to determine, based on the proposal, a unit size of the delivery quantity of the commodities, wherein the unit size is used to adjust the delivery deadline.

### [Supplementary Note 2]

The negotiation device according to Supplementary Note 1,
wherein the unit size determination means is configured to determine the unit size based on a largest common divisor of a union of a set of the delivery quantity agreed before the negotiation and a set of the delivery quantity included in the proposal.

### [Supplementary Note 3]

The negotiation device according to Supplementary Note 2,
wherein the unit size determination means is configured to determine the unit size based on the largest common divisor and the largest delivery quantity among the union.

### [Supplementary Note 4]

The negotiation device according to Supplementary Note 1,
wherein the unit size determination means is configured to determine, as an alternative to the proposal, a counter proposal in which plural delivery quantities of the commodities according to the unit size and respective delivery deadlines for the plural delivery quantities are at least specified.

### [Supplementary Note 5]

The negotiation device according to Supplementary Note 1,
wherein the determined unit size is smaller than a default unit size determined before the negotiation.

### [Supplementary Note 6]

The negotiation device according to Supplementary Note 5,
wherein the default unit size is defined by at least one of SPQ, MOQ, and/or SNP.

### [Supplementary Note 7]

The negotiation device according to Supplementary Note 1,
wherein the negotiator is a supplier supplying the commodities.

### [Supplementary Note 8]

The negotiation device according to Supplementary Note 7,
wherein the proposal acquisition means is configured to acquire the proposal in which the delivery quantity set regardless of a default unit size determined before the negotiation is specified.

### [Supplementary Note 9]

A negotiation method executed by a computer, comprising:
in conducting a negotiation with a negotiator which is a counterparty, acquiring a proposal provided by the negotiator, wherein the proposal includes a delivery quantity of commodities with a delivery deadline;
determining, based on the proposal, a unit size of the delivery quantity of the commodities, wherein the unit size is used to adjust the delivery deadline.

### [Supplementary Note 10]

A program executed by a computer, the program causing the computer to:
in conducting a negotiation with a negotiator which is a counterparty, acquire a proposal provided by the negotiator, wherein the proposal includes a delivery quantity of commodities with a delivery deadline;
determine, based on the proposal, a unit size of the delivery quantity of the commodities, wherein the unit size is used to adjust the delivery deadline.

### [Supplementary Note 11]

A storage medium storing the program according to Supplementary Note 10.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1 Platform providing device
1X Agreement determination device
2 (2A, 2B) Terminal device
3 Network
4 Storage device
100, 100A Negotiation system

What is claimed is:

1. A negotiation device comprising at least one memory configured to store instructions, and
at least one processor configured to execute the instructions to:
in conducting a negotiation with a negotiator which is a counterparty, acquire a proposal provided by the negotiator, wherein the proposal includes a delivery quantity of commodities with a delivery deadline;
determine, based on the proposal, a unit size of the delivery quantity of the commodities, wherein the unit size is used to adjust the delivery deadline.

2. The negotiation device according to claim 1,
wherein the at least one processor is configured to execute the instructions to determine the unit size based on a largest common divisor of a union of
a set of the delivery quantity agreed before the negotiation and
a set of the delivery quantity included in the proposal.

3. The negotiation device according to claim 2,
wherein the at least one processor is configured to execute the instructions to determine the unit size based on the largest common divisor and the largest delivery quantity among the union.

4. The negotiation device according to claim 1,
wherein the at least one processor is configured to execute the instructions to determine, as an alternative to the proposal, a counter proposal in which plural delivery quantities of the commodities according to the unit size and respective delivery deadlines for the plural delivery quantities are at least specified.

5. The negotiation device according to claim 1,
wherein the determined unit size is smaller than a default unit size determined before the negotiation.

6. The negotiation device according to claim 5,
wherein the default unit size is defined by at least one of SPQ, MOQ, and/or SNP.

7. The negotiation device according to claim 1,
wherein the negotiator is a supplier supplying the commodities.

8. The negotiation device according to claim 7,
wherein the at least one processor is configured to execute the instructions to acquire the proposal in which the delivery quantity set regardless of a default unit size determined before the negotiation is specified.

9. A negotiation method executed by a computer, comprising:
in conducting a negotiation with a negotiator which is a counterparty, acquiring a proposal provided by the negotiator, wherein the proposal includes a delivery quantity of commodities with a delivery deadline;
determining, based on the proposal, a unit size of the delivery quantity of the commodities, wherein the unit size is used to adjust the delivery deadline.

10. A non-transitory computer readable storage medium storing a program executed by a computer, the program causing the computer to:
in conducting a negotiation with a negotiator which is a counterparty, acquire a proposal provided by the negotiator, wherein the proposal includes a delivery quantity of commodities with a delivery deadline;
determine, based on the proposal, a unit size of the delivery quantity of the commodities, wherein the unit size is used to adjust the delivery deadline.
